(19) United States
(12) Patent Application Publication
(10) Pub. No.: US 2026/0117753 A1
(43) Pub. Date: Apr. 30, 2026

(54) HYDRO PNEUMATIC ENERGY WHEEL

(71) Applicant: Ashraf Hossain, Norwich, CT (US)

(72) Inventor: Ashraf Hossain, Norwich, CT (US)

(21) Appl. No.: 19/367,751

(22) Filed: Oct. 23, 2025

Related U.S. Application Data
(60) Provisional application No. 63/711,851, filed on Oct. 25, 2024.

(51) Int. Cl. F03G 7/08; B60K 25/10

(52) U.S. Cl. CPC F03G 7/081; B60K 25/10; B60K 2025/106

(57) ABSTRACT

A system, apparatus, and method are provided through which deformation of a tire of a vehicle is used to push air or hydraulic fluid through a piston, which is used in the generation of energy for the vehicle. The tire deformation causes a piston arranged in the tire to push air through an air line, which supplies the compressed air to a fan attached to an alternator for battery charging.

### CROSS-REFERENCE TO RELATED APPLICATIONS

The present application claims the benefit of U.S. Provisional Application No. 63/711,851 filed Oct. 25, 2024, which is hereby incorporated by reference in its entirety.

### BACKGROUND OF THE DISCLOSURE

As electric vehicles gain prominence, there continues to be a need to improve battery life and driving distance on a single charge on the vehicle's battery. The present application seeks to solve these shortcomings in the art with a system utilizing the vehicle's movement to harness additional power.

### SUMMARY OF THE DISCLOSURE

The present application relates to a hydro-pneumatic energy wheel, system, and method which can serve as a next generation charging system for electric cars. The system of the present application relies upon tire deformation caused by the weight of a vehicle on the tire during its motion.

In accordance with the present application, a system, apparatus, and method are provided through which this deformation can be used to push air through a piston, which is used in the generation of energy for the vehicle. The tire deformation causes a piston to push air through an airline, which supplies the compressed air to a fan attached to an alternator for battery charging.

In accordance with a first aspect of the present application, a system is provided comprising a wheel comprising a tire and a rim; at least one piston comprising a piston rod and arranged in the tire between an outer edge of the tire and the rim; a fluid line arranged at an end of the piston; and an alternator. Rotation of the wheel on a ground surface causes a deformation of the tire and compression of the piston rod and wherein the compression of the piston rod causes a fluid to be provided to power the alternator.

In embodiments of the system of the first aspect of the application, the compression of the piston rod causes compressed air to be provided to a first end of the fluid line. The system may further comprise a rotary union receiving a second end of the fluid line opposite the first end and configured to receive the compressed air from the piston and provide the compressed air to turn the alternator. The system may still further comprise a plurality of pistons arranged around the tire in between the outer edge of the tire and the rim, each piston comprising a piston rod, each piston rod configured to be compressed upon deformation of the tire by a ground surface, and each piston configured to provide compressed air to a corresponding fluid line turn the alternator upon compression of the piston rod. The system may comprise a battery configured to be charged by turning of the alternator. The system may still further comprise a plurality of check valves configured to prevent air from flowing back towards the piston after retraction of the piston rod after tire deformation is completed.

In a further embodiment of the system of the first aspect of the application, the compression of the piston rod causes a hydraulic fluid to be provided to a first end of the fluid line. The system may further comprise a plurality of pistons arranged around the tire in between the outer edge of the tire and the rim, each piston comprising a piston rod, each piston rod configured to be compressed upon deformation of the tire by a ground surface, and each piston configured to provide hydraulic fluid. The system may further comprise a cylinder configured to store the hydraulic fluid of the system. The system may still further comprise a multichannel rotary union configured to transfer fluid to the front of the wheel; and a secondary piston configured to push a rod with amplified force which is translated into a rotational mechanism spin an alternator for charging a battery charging.

In accordance with any of the above-referenced embodiments of the system of the first aspect of the present application, the system may further comprise a cooling fluid configured to cool the system and prevent the pistons from overheating.

In accordance with a second aspect of the present application, an apparatus is provided, comprising: a wheel comprising a tire and a rim; at least one piston comprising a piston rod, and arranged in the tire between an outer edge of the tire and the rim; and a fluid line arranged at an end of the piston. The rotation of the wheel on a ground surface causes a deformation of the tire and compression of the piston rod to generate a fluid to be provided to a power supply.

In an embodiment of the apparatus of the second aspect of the present application, the compression of the piston rod causes a compressed air to be provided to a first end of the fluid line. The apparatus may further comprise a plurality of pistons arranged around the tire in between the outer edge of the tire and the rim, each piston comprising a piston rod, each piston rod configured to be compressed upon deformation of the tire by a ground surface, and each piston configured to provide compressed air to a corresponding fluid line; and a rotary union receiving a second end of each fluid line and configured to receive the compressed air from the piston and provide the compressed air to the power source. The apparatus may still further comprise a plurality of check valves configured to prevent air from flowing back towards the piston after retraction of the piston rod after tire deformation is completed.

In a further embodiment of the apparatus of the second aspect of the present application, compression of the piston rod causes a hydraulic fluid to be provided to a first end of the fluid line.

In accordance with a third aspect of the present application, a method is provided, the method comprising: deforming a tire of a wheel by a ground force, the tire having arranged therein a piston comprising a piston rod; compressing the piston rod of a piston by deforming the tire; providing a fluid by the compressed piston to an alternator; and turning the alternator to charge a battery.

In an embodiment of the method of the third aspect of the present application, the fluid is compressed air. The method may further comprise compressing a plurality of pistons arranged around the tire in between the outer edge of the tire and the rim, each piston comprising a piston rod, each piston rod compressed upon deformation of the tire by a ground surface at the location of the corresponding piston, and each piston configured to provide compressed air to a corresponding fluid line to turn the alternator.

In further embodiments of the method of the third aspect of the present application, the fluid is a hydraulic fluid.

### BRIEF DESCRIPTION OF THE FIGURES

FIG. 1 shows an illustration of tire deformation according to the prior art;

FIG. 2 shows a tire with piston attached to the wheel rim according to the present application;

FIG. 3 shows a rotating tire with piston attached to the wheel rim according to the present application;

FIG. 4 shows a rotating tire with piston and associated rotary union attached to the wheel rim according to the present application;

FIG. 5 shows a rotating tire with piston and associated rotary union attached to the wheel rim for turning an alternator fan according to the present application;

FIG. 6 shows a rotating tire with a plurality of pistons and associated rotary union attached to the wheel rim for turning an alternator fan according to the present application

FIG. 7 shows a valve arrangement according to the system of the present application;

FIG. 8 shows a diagram of a system according to the present application; and

FIG. 9 shows a further diagram of a system according to the present application.

### DETAILED DESCRIPTION OF THE FIGURES

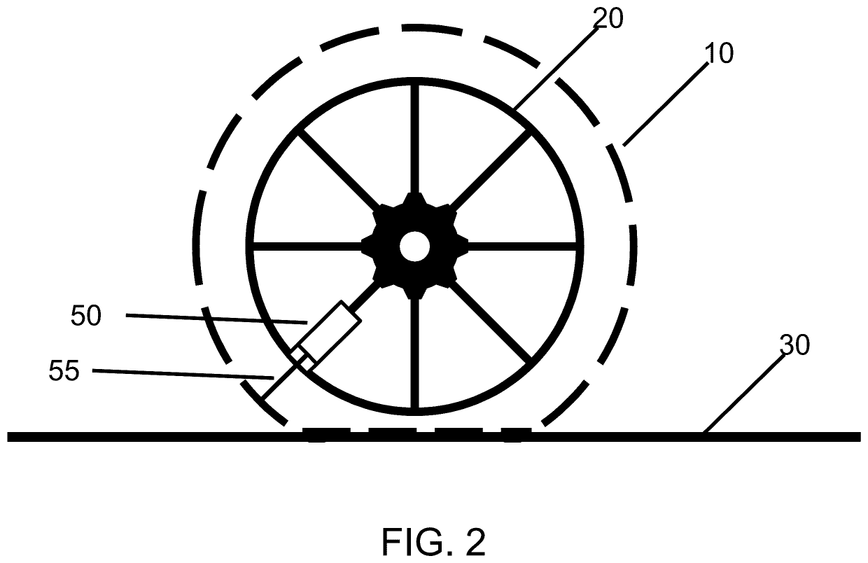

Exemplary diagrams of the system of the present application are shown in FIGS. 2-9.

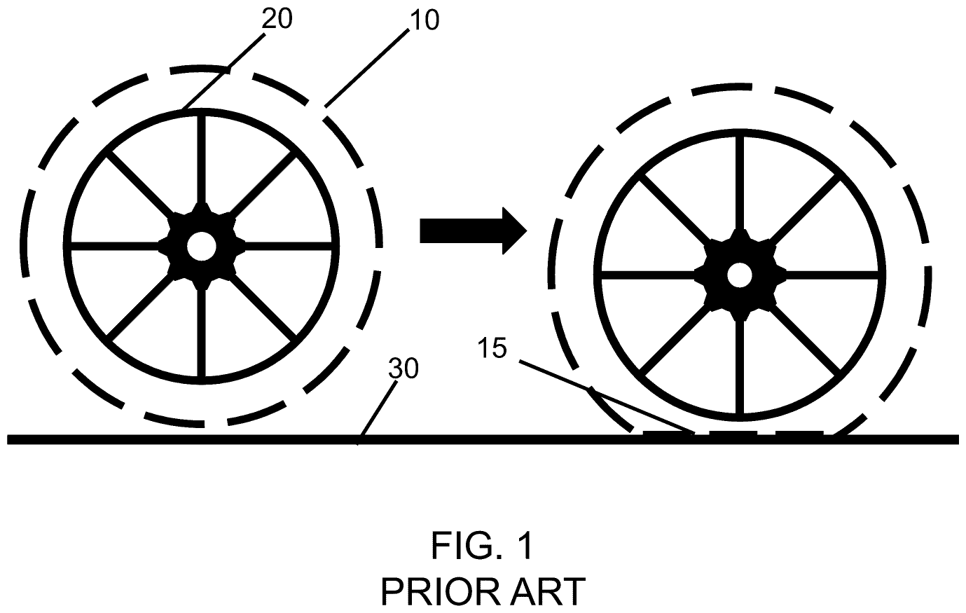

As background, automotive tires deform with the weight of the vehicle. For example, FIG. 1 shows a diagram of the tire 10 deformation on the right side. When the tire 10 comes in contact with a ground surface 30, the bottom of the tire deforms 15 to take the shape of the ground 30.

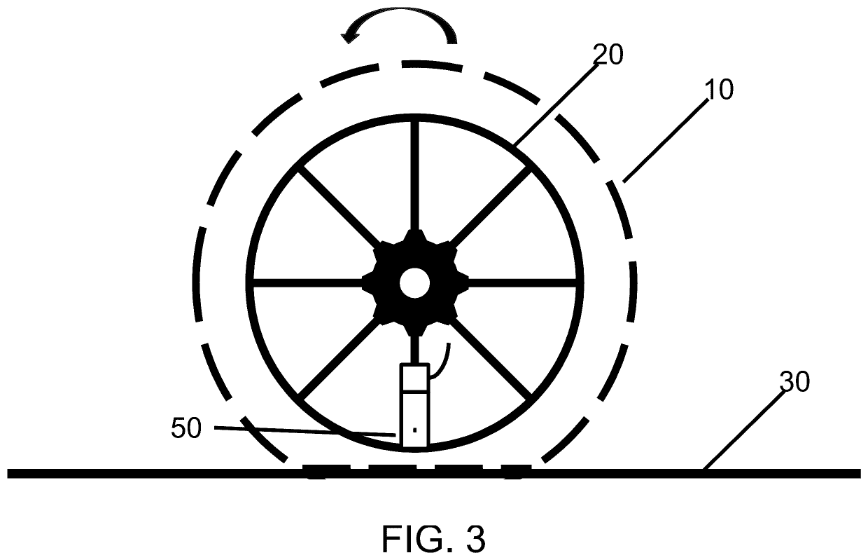

The present application utilizes this mechanism of tire deformation to create energy that can be harnessed by the vehicle. As shown in FIG. 2, a piston 50 is attached to the rim 20 of the wheel. The piston 50 comprises a piston rod 55 affixed to the tire 10. As the tire 10 rotates counter-clockwise, shown for example in FIG. 3, the tire 10 deforms, which pushes the piston rod 55 upwards.

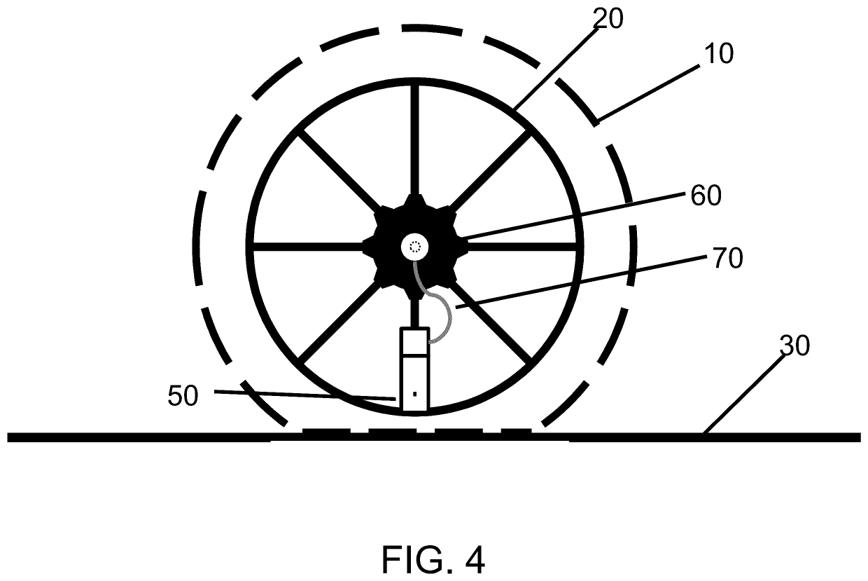

The upward motion of the piston rod 55 causes the piston 50 to compress and sends air through an air line 70, shown for example in FIG. 4. A rotary union 60 can be pressed into the center of the wheel. The air line 70 connects to the front of the rotary union 60 and transfers the compressed air to the opposite end of the union 60. The opposite end of the rotary union 60 can be attached to the body of the vehicle (not shown).

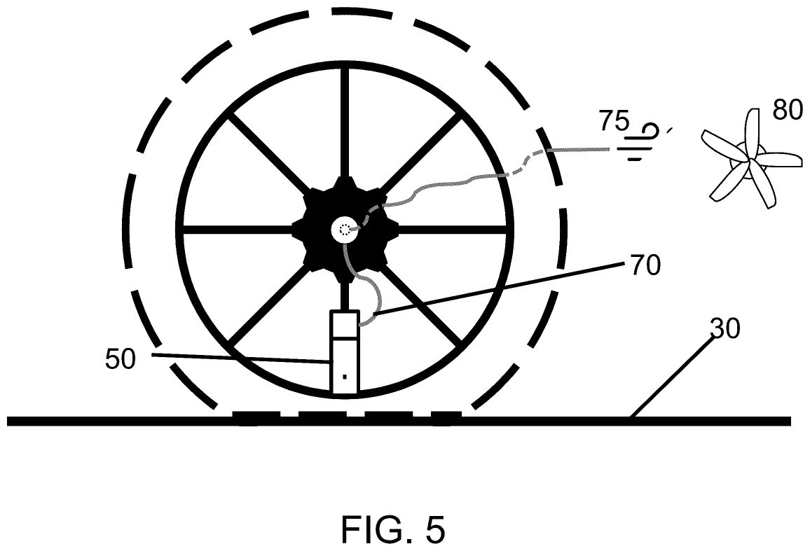

FIG. 5 shows a diagram of the system of the application including an alternator fan 80. Another air line 70 can connect to the back end of the rotary union 60. The compressed air 75 can travel through the air line 70 and blow a fan 80 that is attached to an alternator for charging a battery. It is noted that while not illustrated, each of these components including the fan, alternator, and battery are provided in the vehicle.

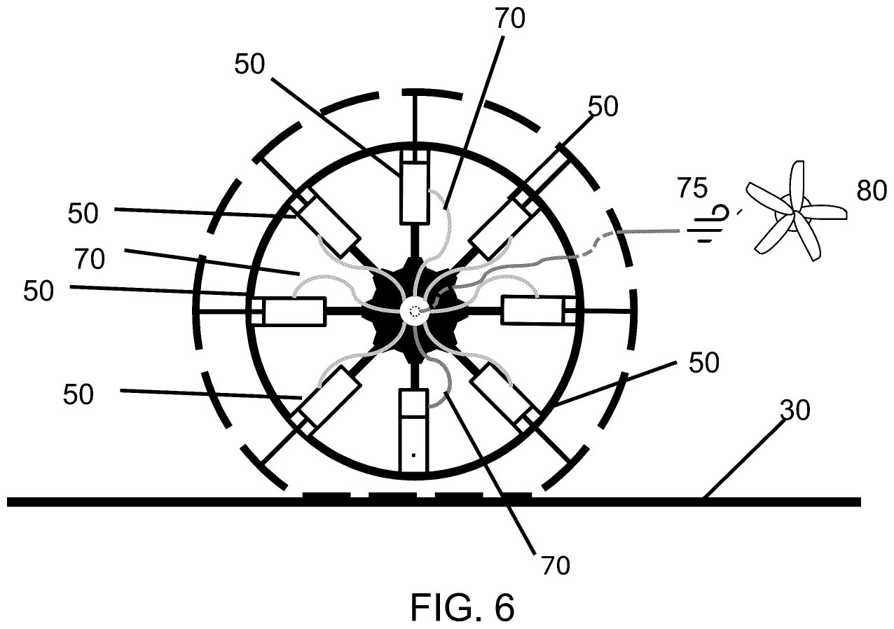

While FIGS. 2-5 show a single piston 50 for explanatory purposes, in embodiments of the system of the present application, a plurality of such pistons 50 can be placed inside the tire 10 around the wheel. This is shown for example in FIG. 6. At each of the pistons 50, air can be compressed by the tire 10 deformation by pushing of the piston rod 55 and, and routed towards the alternator 80 at more frequent intervals with respect to the motion of the tire 10. Each time the tire 10 is deformed at the location of a piston 50, the piston rod 55 pushes upward to provide compressed air 75 to the alternator fan 80. The frequency and amount of compressed air to the alternator is increased in this arrangement.

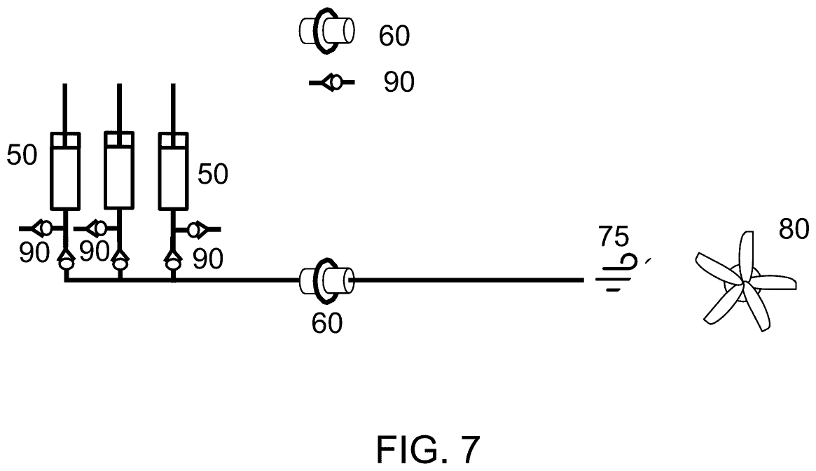

The system further comprises a plurality of check valves 85. The check valves 85 are unidirectional preventing air from flowing back towards the piston 50 after the piston rod 55 retracts after the deformation is complete and the piston 50 retracts. A diagram of an exemplary valve arrangement is shown for example in FIG. 7. In this example, there are three check valves 85 at the bottom (i.e., bottom of the page and closest to the rotary union 60), which allow air to flow in only a single direction towards the rotary union 60. There are also three check valves 85 on the top (i.e., above the other valves 85 on the page and closest to the pistons 50), which allow air from the environment into the pistons 50 during piston retraction, which prevents suction in the system.

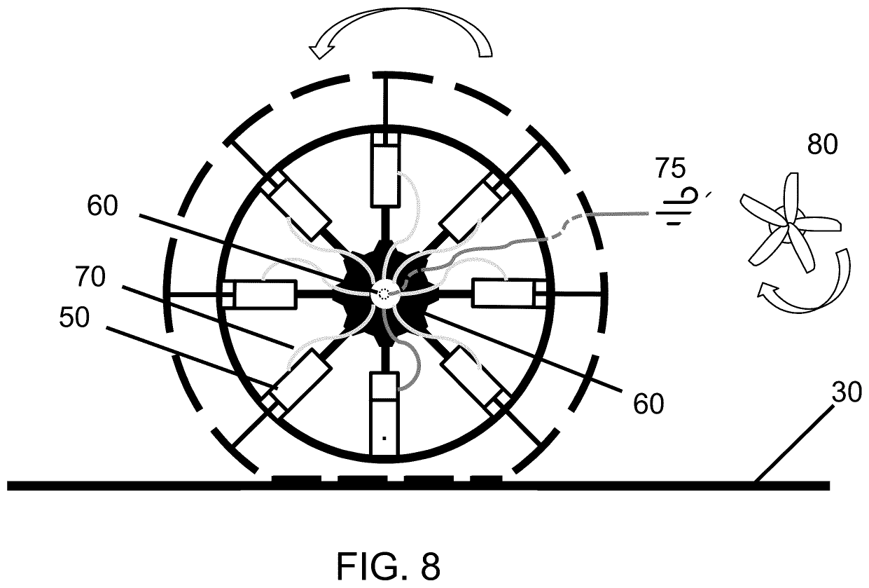

An overview of the system is shown in FIG. 8. Ground reaction force on a vehicle tire 10 is used to compress air inside a piston 50, route the air through a rotary union 60, and used to activate an alternator turbine 80 for charging a battery throughout the motion of the vehicle. Energy can be harvested from the road during the motion of the vehicle. For example, energy can be stored with very high efficiency during downhill motion of the vehicle when the battery is less necessary for supplying power. This system can be used to drastically increase the range of electric vehicles.

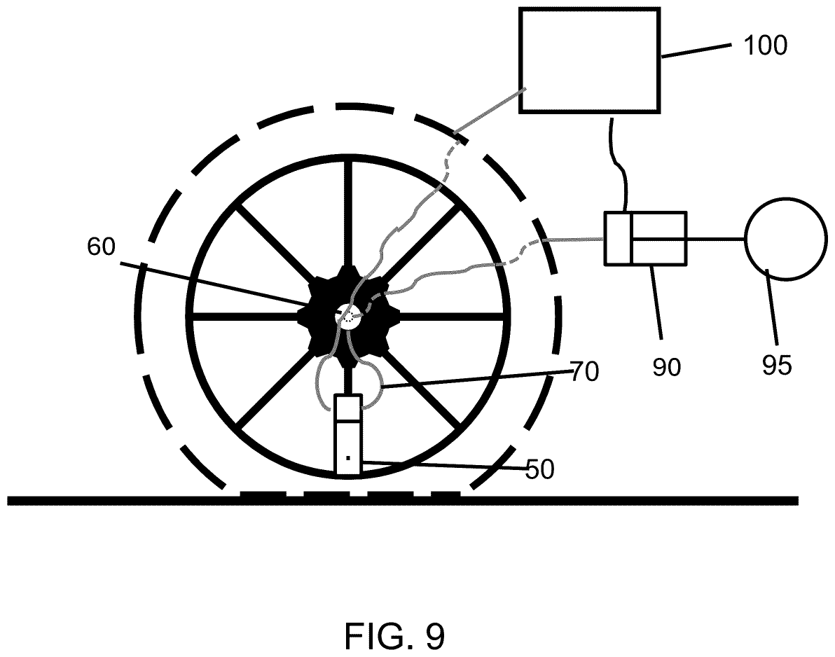

In further embodiments, instead of using air, hydraulics with fluids can be used to amplify the energy if needed. FIG. 9 shows an overview of an example of such a hydraulic system. A master cylinder 100 can be used to conserve the fluid within the system. A multichannel rotary union 60 can be used to transfer fluid to the front of the wheel. Instead of blowing air, a secondary piston 50 can push a rod with amplified force. A translational to rotational mechanism spin an alternator 80 for battery charging. A cooling fluid may also be provided in the air or hydraulic system to cool the system and prevent the pistons from overheating.

As used herein, directional or positional terms such as “front”, “rear”, “upper”, “lower”, “top”, “bottom”, etc., are used for explanatory purposes only to describe the system as illustrated in the figures.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. A system comprising:
a wheel comprising a tire and a rim;
at least one piston comprising a piston rod, and arranged in the tire between an outer edge of the tire and the rim;
a fluid line arranged at an end of the piston; and
an alternator;
wherein rotation of the wheel on a ground surface causes a deformation of the tire and compression of the piston rod; and
wherein the compression of the piston rod causes a fluid to be provided to power the alternator.

2. The system according to claim 1, wherein the compression of the piston rod causes compressed air to be provided to a first end of the fluid line.

3. The system according to claim 2, further comprising a rotary union receiving a second end of the fluid line opposite the first end and configured to receive the compressed air from the piston and provide the compressed air to turn the alternator.

4. The system according to claim 3, wherein the system comprises a plurality of pistons arranged around the tire in between the outer edge of the tire and the rim, each piston comprising a piston rod, each piston rod configured to be compressed upon deformation of the tire by a ground surface, and each piston configured to provide compressed air to a corresponding fluid line turn the alternator upon compression of the piston rod.

5. The system according to claim 4, further comprising a battery configured to be charged by turning of the alternator.

6. The system according to claim 4, further comprising a plurality of check valves configured to prevent air from flowing back towards the piston after retraction of the piston rod after tire deformation is completed.

7. The system according to claim 1, wherein the compression of the piston rod causes a hydraulic fluid to be provided to a first end of the fluid line.

8. The system according to claim 7, further comprising a plurality of pistons arranged around the tire in between the outer edge of the tire and the rim, each piston comprising a piston rod, each piston rod configured to be compressed upon deformation of the tire by a ground surface, and each piston configured to provide hydraulic fluid.

9. The system according to claim 8, further comprising a cylinder configured to store the hydraulic fluid of the system.

10. The system according to claim 9, further comprising:
a multichannel rotary union configured to transfer fluid to the front of the wheel; and
a secondary piston configured to push a rod with amplified force which is translated into a rotational mechanism spin an alternator for charging a battery charging.

11. The system according to claim 1, further comprising a cooling fluid configured to cool the system and prevent the pistons from overheating.

12. An apparatus comprising:
a wheel comprising a tire and a rim;
at least one piston comprising a piston rod, and arranged in the tire between an outer edge of the tire and the rim; and
a fluid line arranged at an end of the piston;
wherein rotation of the wheel on a ground surface causes a deformation of the tire and compression of the piston rod to generate a fluid to be provided to a power supply.

13. The apparatus according to claim 12, wherein the compression of the piston rod causes a compressed air to be provided to a first end of the fluid line.

14. The apparatus according to claim 13, wherein the system comprises a plurality of pistons arranged around the tire in between the outer edge of the tire and the rim, each piston comprising a piston rod, each piston rod configured to be compressed upon deformation of the tire by a ground surface, and each piston configured to provide compressed air to a corresponding fluid line; and
a rotary union receiving a second end of each fluid line and configured to receive the compressed air from the piston and provide the compressed air to the power source.

15. The apparatus according to claim 14, further comprising a plurality of check valves configured to prevent air from flowing back towards the piston after retraction of the piston rod after tire deformation is completed.

16. The apparatus according to claim 12, wherein the compression of the piston rod causes a hydraulic fluid to be provided to a first end of the fluid line.

17. A method comprising:
deforming a tire of a wheel by a ground force, the tire having arranged therein a piston comprising a piston rod;
compressing the piston rod of a piston by deforming the tire;
providing a fluid by the compressed piston to an alternator; and
turning the alternator to charge a battery.

18. The method according to claim 17, wherein the fluid is compressed air.

19. The method according to claim 18, further comprising compressing a plurality of pistons arranged around the tire in between the outer edge of the tire and the rim, each piston comprising a piston rod, each piston rod compressed upon deformation of the tire by a ground surface at the location of the corresponding piston, and each piston configured to provide compressed air to a corresponding fluid line to turn the alternator.

20. The method according to claim 17, wherein the fluid is a hydraulic fluid.
